(19) United States
(12) Patent Application Publication
(10) Pub. No.: US 2013/0102294 A1
(43) Pub. Date: Apr. 25, 2013

(54) SYSTEM AND METHOD FOR NAVIGATING A PLURALITY OF COLLEGES AND UNIVERSITIES

(71) Applicant: Thomas Spellman, Amanda, OH (US)

(72) Inventor: Thomas Spellman, Amanda, OH (US)

(21) Appl. No.: 13/277,194

(22) Filed: Oct. 19, 2011

(51) Int. Cl. H04W 4/04

(52) U.S. Cl. 455/414.2

(57) ABSTRACT

The present invention is a system to navigate a plurality of colleges and universities that includes a server system, one or more smartphones and a communications network where the server system is in communication with the smartphones over the communications network. The system specifically includes a college navigator smartphone app that includes a plurality of interactive maps and a plurality of schedule information that resides on the server system and a plurality of app updates that are provided to the college navigator app and to keep the system current. The present invention also includes a corresponding method for using a smartphone to navigate a plurality of college and university campuses.

### TECHNICAL FIELD & BACKGROUND

Attempting to navigate an unfamiliar college campus can often be a difficult and confusing task. The school's website can also be cumbersome and complicated to navigate, often leaving students unable to find pertinent and/or vital information.

The present invention generally relates to a smartphone app system and method of use. More specifically, the invention is an IPHONE™ app system and method of us.

It is an object of the invention to provide an IPHONE™ app for college students designed to assist students navigating a variety of college and university campuses.

It is an object of the invention to provide an IPHONE app with useful information to students attending, or planning to attend different colleges and universities throughout the world.

It is an object of the invention to provide an IPHONE app with a plurality of locations and buildings on a college or university with an explanation of what each location and building is and what activities occur in each location and building.

What is really needed is an IPHONE™ app for college students designed to assist students navigating a variety of college and university campuses with useful information to students attending, or planning to attend different colleges and universities throughout the world with a plurality of locations and buildings on a college or university with an explanation of what each location and building is and what activities occur in each location and building.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a computerized system for navigating a plurality of colleges and universities, in accordance with one embodiment of the present invention.

FIG. 2A illustrates block diagram of a server system of a computerized system for navigating a plurality of colleges and universities, in accordance with one embodiment of the present invention.

FIG. 2B illustrates block diagram of a college navigator app of a computerized system for navigating a plurality of colleges and universities, in accordance with one embodiment of the present invention.

FIG. 3 illustrates a front perspective view of an IPhone with an app for navigating a plurality of colleges and universities, in accordance with one embodiment of the present invention.

FIG. 4 illustrates a flowchart of a method for using a smartphone for navigating a plurality of colleges and universities, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

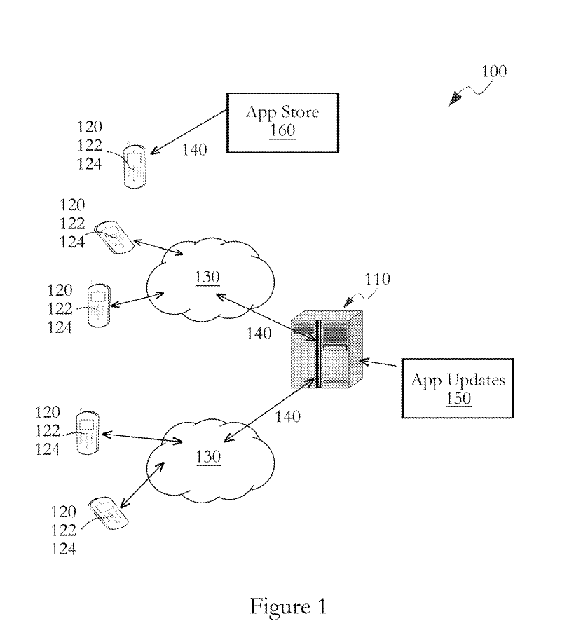

FIG. 1 illustrates a system overview of a computerized system 100 for navigating a plurality of colleges and universities, in accordance with one embodiment of the present invention.

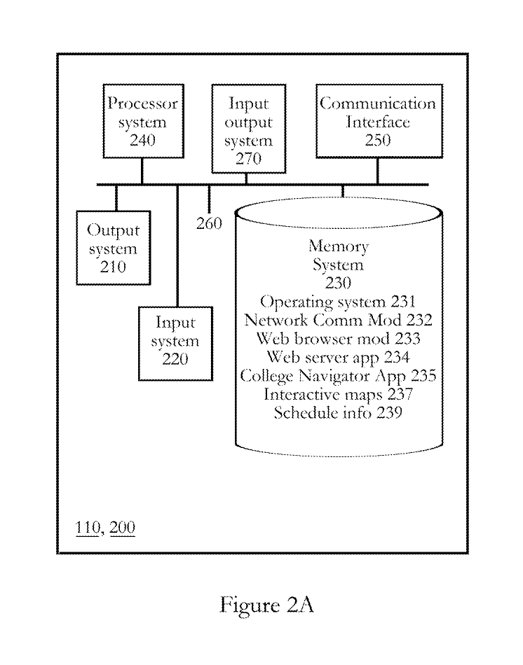

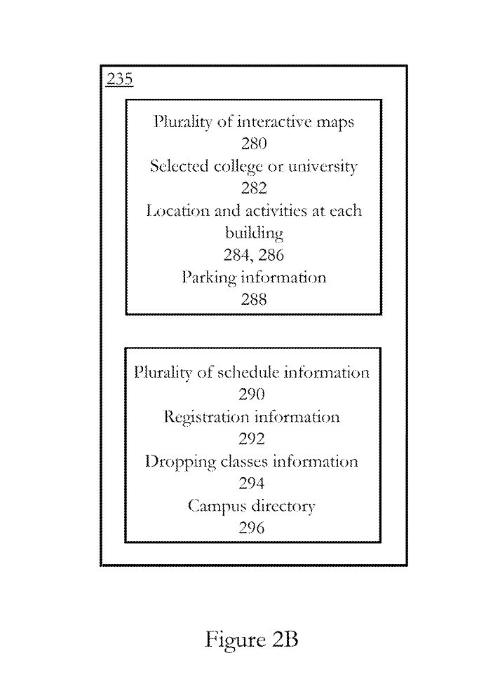

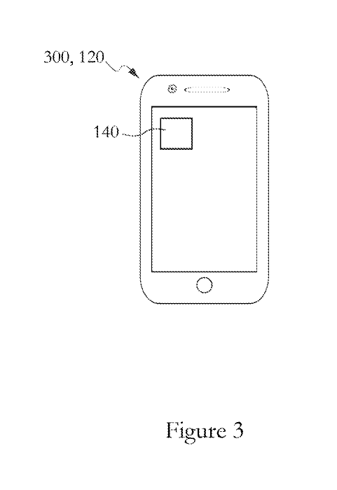

The computerized system 100 includes a server system 110, one or more smartphones 120, a communications network 130, a college navigator app 140, a plurality of app updates 150 and an app store 160. The server system 110 may have one or more servers and may include additional components and/or may not include all of the components listed above. Further details regarding the server system 110 are described in FIG. 2A. The smartphones 120 are typically an IPHONE™ 122 manufactured by Apple Inc. of Cupertino, Calif. as depicted in FIG. 3 although other suitable smartphones such as a BLACKBERRY™ device manufactured by Research in Motion (RIM) of Waterloo, Ontario, Canada can also be utilized with the computerized system. These smartphones 120 serve as a client system 124 in the computerized system 100. The smartphone 120 supports special software applications operating on various operating systems and can be JAVA enabled or other suitable programming language and computing platform or Binary Runtime Environment for Wireless (BREW) enabled or other suitable application development platform. The communications network 130 may be any one of, or any combination of, one or more Local Area Networks (LANs), Wide Area Networks (WANs), wireless networks, telephone networks, the Internet and/or other suitable networks. The communications network 130 may also include one or more wireless portals. The college navigator app 140 includes smartphone software that is downloaded from the server system 110 to the smartphone 120. Further details regarding the college navigator app 140 are provided in FIGS. 2A and 2B. The app updates 150 are provided to keep the college navigator app 140 and computerized system 100 current. The app store 160 serves as a second source for providing the college navigator app 140 download to the computerized system 100 in contrast to downloading the college navigator app 140 over the communications network 130 from the server system 110.

FIG. 2A illustrates block diagram of a server system 200 of a computerized system for navigating a plurality of colleges and universities, in accordance with one embodiment of the present invention.

The server system 200 may include an output system 210, an input system 220, a memory system 230, a processor system 240, a communications interface 250, a communications system 260 and an input/output system 270. The server system 200 may include additional components and/or may not include all of the components listed above. The server system 200 is the same server system 110 illustrated and described in FIG. 1 and its description.

The output system 210 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

The input system 220 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example.

The memory system 230 may include, for example, any one of, some of, any combination of, or all of a long term storage system, such as a hard drive; a short term storage system, such as random access memory; a removable storage system, such as a floppy drive or a removable drive and/or flash memory. Memory system 230 may include one or more machine-readable mediums that may store a variety of different types of information. The term machine-readable medium is used to refer to any medium capable carrying information that is readable by a machine. One example of a machine-readable medium is a computer-readable medium. Memory system 230 may store one or more machine instructions for producing web pages for and collecting information for operators or establishments and/or patrons regarding wait-times at different times of the day.

The memory system 230 may also include an operating system 231, a network communications module 232, a web browser module 233, a web server application 234 and a college navigator app 235. The operating system 231 is provided on the memory system 230. The communications module 232 enables the server system 200 to communicate on the communications network 130 and is stored on the memory system 230. The web browser module 233 allows for browsing the Internet that is stored on the memory system 230. The web server application 234 is software provided to allow for browsing on the Internet. The college navigator app 235 is software provided to store a plurality of interactive college maps 237 and a plurality of schedule information 239 that is used by the server system 200. The college navigator app 235 is the same college navigator app 140 that is downloaded to the smartphone 120 described and illustrated in previous FIG. 1 and is further described in FIG. 2B and its description.

The processor system 240 may include any one of, some of, any combination of, or all of multiple parallel processors, a single processor, a system of processors having one or more central processors and/or one or more specialized processors dedicated to specific tasks. Processor system 240 may include one or more digital signal processors (DSPs) in addition to or in place of one or more central processing units (CPUs) and/or may have one or more digital signal processing programs that run on one or more CPU. Processor system 240 may implement the machine instructions stored in memory system 230.

The communication interface 250 allows the server system 200 to interface with the communications network 130 described in previous FIG. 1. Communications system 260 communicatively links output system 210, input system 220, memory system 230, processor system 240 and/or input/output system 270 to each other. Communications system 260 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input/output system 270 may include devices that have the dual function as input and output devices. For example, input/output system 270 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 270 is optional and may be used in addition to or in place of output system 210 and/or input device 220.

FIG. 2B illustrates block diagram of a college navigator app 235 of a computerized system for navigating a plurality of colleges and universities, in accordance with one embodiment of the present invention.

The college navigator app 235 is the same college navigator app described and illustrated in FIG. 2A and its description. As also previously described and illustrated in FIG. 2A and its description, the college navigator app 235 includes a plurality of interactive maps 280 and a plurality of schedule information 290. The interactive maps 280 include a map of the selected college or university campus 282 with the location and activities 284 performed at each building 286 on the interactive maps 280. The interactive maps 280 also provide parking information 288 where parking is permitted as well as stores and restaurants 289 on the chosen campus. The schedule information 290 includes registration information 292, dropping class information 294 and a campus directory 296. Other suitable interactive maps 280 and schedule information 290 may also be provided by the college navigator app 235.

The present invention is an iPhone college and university app. It will provide useful information to students attending, or planning to attend a college or university campus located anywhere throughout the world. It will also update these students as to what activities are occurring on each college and university. The app will solve the problem of not knowing where to go on a university or college campus or how to get there. On many of todays' college and university campuses, new students can get easily overwhelmed and confused. The app will include a plurality of maps with different location related information such as where buildings, stores and restaurants are located. It will also provide times for registering classes, dropping classes and a college or university directory. The app will also be a great way for a college or university to contact an individual with any important specific information pertaining to an individual involved with the college or university. It will also give the student an opportunity to announce any important information which can be utilized to alert local police or security if needed.

The app is designed for future students, current students and faculty and staff. Future students would be less likely to purchase this app unless they had an interest in attending a specific college or university such as Ohio University for example or other suitable college or university. Current students would be more inclined to purchase this app, due to the relevance of attending a specific college or university because of the access to information provided on the app would help their experience as a student at the specific college or university. Faculty and staff would be likely to use the information on the app and provide information for their students. If the faculty or staff were new to one of the campuses, the app would provide them with invaluable information on getting from place to place on the campus. The app would also be a great way for local businesses to advertise and draw in customers that are on or in close proximity to the colleges and universities incorporated on the app as well.

The smartphone app offers students and other persons associated with a college or university an interactive map as well as related information involving the learning institution of choice and is a superb alternative to current methods of familiarizing students with their college or university. Easy to use, a user simply downloads the app from any suitable smartphone such as an IPhone or Blackberry to receive maps with the locations of buildings, stores, and restaurants on campus, as well as information pertaining to registration, dropping classes and a directory. Practical and convenient, the app also allows users to announce any important information and even rapidly alert local police or security when needed. The app also allows students to sync their phones with the appropriate college website to maintain a current calendar. The app is readily available from any Smartphone app store or can be downloaded over a communications network (such as the Internet) and server system as well. The app features a plurality of interactive maps with the locations of all buildings, stores, and restaurants on campus, while also affording local businesses a place in which to advertise, directly reaching their target demographic. The app is designed to not only work on smartphones, but any and all similar computerized devices as well.

FIG. 3 illustrates a front perspective view of an IPhone 300 with an app for navigating a plurality of colleges and universities, in accordance with one embodiment of the present invention.

As previously indicated in FIG. 1, the IPhone 300 can be one of the types of smartphones 120 that can receive a downloaded college navigator app 140 and is typically the smartphone type utilized with the college navigator app. The details and features of the IPhone 300 are described in U.S. Pat. No. 7,966,578 by Apple Computer.

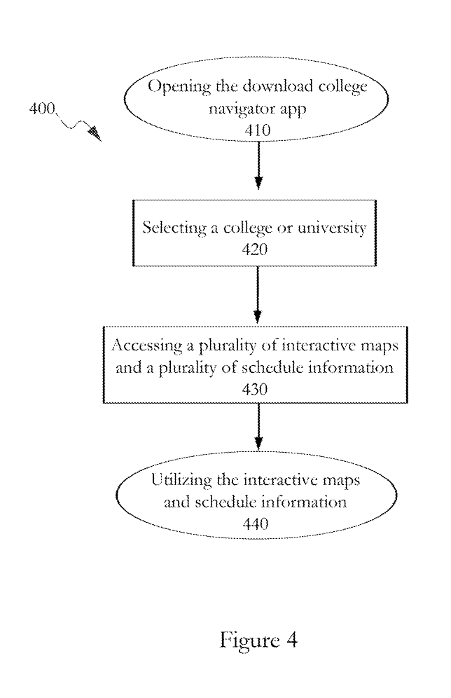

FIG. 4 illustrates a flowchart of a method 400 for using a smartphone for navigating a plurality of colleges and universities, in accordance with one embodiment of the present invention.

The method 400 includes the steps of opening the downloaded college navigator app 410, selecting a college or university 420, accessing a plurality of interactive maps and a plurality of schedule information 430 and utilizing the interactive maps and schedule information 440. The opening the downloaded college navigator app 410 step includes utilizing a smartphone such as an IPhone, a Blackberry or other suitable smartphone to download the college navigator app and opening the college navigator app with the smartphone. The selecting a college or a university 420 step includes simply selecting the desired college or university that the user desires from the college navigator app. The accessing a plurality of interactive maps and a plurality of schedule information 430 step includes simply manipulating the college navigator app to provide the desired interactive maps and schedule information at the previously selected college or university. The utilizing the interactive maps and schedule information 440 step includes reading the accessed interactive maps and schedule information and utilizing as needed or desired by the user.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to navigate a plurality of colleges and universities, comprising:
a server system;
one or more smartphones;
a communications network where said server system is in communication with said smartphones over said communications network downloads;
a college navigator app that includes a plurality of interactive maps and a plurality of schedule information that resides on said server system; and
a plurality of app updates that are provided to said college navigator app and to keep said system current.

2. The system according to claim 1, wherein said smartphones are a client system.

3. The system according to claim 1, wherein said smartphone is an IPhone.

4. The system according to claim 1, wherein said smartphone is a Blackberry.

5. The system according to claim 1, wherein said smartphone is JAVA enabled.

6. The system according to claim 1, wherein said smartphone is binary runtime environment for wireless enabled.

7. The system according to claim 1, wherein said communications network is selected from the group consisting of one or more local area networks, wide area networks, wireless networks, telephone networks and the Internet.

8. The system according to claim 1, wherein said interactive maps include a map of a selected college or a university campus.

9. The system according to claim 1, wherein said interactive maps provide a location of all a plurality of buildings and a plurality of activities performed at said buildings on said interactive maps.

10. The system according to claim 1, wherein said interactive maps provide a plurality of parking information on said selected campus.

11. The system according to claim 1, wherein said interactive maps provide a plurality of locations of a plurality of stores and a plurality of restaurants on said chosen campus.

12. The system according to claim 1, wherein said schedule information includes registration information and dropping class information.

13. The system according to claim 1, wherein said schedule information includes a campus directory.

14. The system according to claim 1, wherein said college navigator app is downloaded from an app store.

15. A method for using a smartphone to navigate a plurality of college and university campuses, comprising:
opening a downloaded college navigator app with said smartphone over a communications network;
selecting a college or university from said downloaded college navigator app;
accessing a plurality of interactive maps and a plurality of schedule information from said downloaded college navigator map; and
utilizing said interactive maps and schedule information.

16. The method according to claim 15, wherein said smartphone is an IPhone.

17. The method according to claim 15, wherein said smartphone is a Blackberry.

18. The method according to claim 15, wherein said communications network is selected from the group consisting of one or more local area networks, wide area networks, wireless networks, telephone networks and the Internet.

19. The method according to claim 15, wherein said accessing a plurality of interactive maps and a plurality of schedule information includes manipulating said college navigator app to provide said desired interactive maps and schedule information at said selected college or university.

20. The method according to claim 15, wherein said utilizing said interactive maps and schedule information includes reading said accessed interactive maps and schedule information and utilizing said interactive maps and schedule information as needed or desired by a user.
